(19) United States
(12) Patent Application Publication
(10) Pub. No.: US 2013/0247287 A1
(43) Pub. Date: Sep. 26, 2013

(54) FABRIC AND ARC PROTECTION WORK CLOTHING CONTAINING MODACRYLIC FIBERS

(71) Applicants: Atsushi Mizobuchi, Osaka (JP); Takeshi Miura, Osaka (JP)

(72) Inventors: Atsushi Mizobuchi, Osaka (JP); Takeshi Miura, Osaka (JP)

(73) Assignee: KANEKA CORPORATION, Osaka-shi, Osaka (JP)

(21) Appl. No.: 13/991,792

(22) PCT Filed: Dec. 6, 2011
(86) PCT No.: PCT/JP2011/078196

§ 371 Date: Jun. 5, 2013

(30) Foreign Application Priority Data
Dec. 9, 2010 (JP) 2010-275154

(51) Int. Cl. A62B 17/00

(52) U.S. Cl. CPC A62B 17/003
USPC 2/455; 428/221

(57) ABSTRACT

It is an object of the present invention to inexpensively provide arc protection work clothing that is lighter than that of the conventional art; specifically, fabric and arc protection work clothing having a specific ATPV of not less than 1.3 (cal•yd²)/(cm²•oz). The fabric contains 40 to 65% by weight of modacrylic fibers based on the fabric weight, the modacrylic fibers containing at least 8% by weight of antimony oxide relative to the resin weight of the modacrylic fibers, 26 to 45% by weight of natural cellulosic fibers, 5 to 15% by weight of nylon fibers, and 1 to 20% by weight of para-aramid fibers, and arc protection work clothing can be made from the fabric.

### TECHNICAL FIELD

The present invention relates to thread, fabric, and clothing that can be used preferably for arc protection work clothing, and in particular, to arc protection work clothing.

### BACKGROUND ART

Among firefighters, electrical fitters, and other operators in environments exposed to danger of an electric arc and a fire that may be caused by an arc phenomenon, there is a demand for work clothing having excellent arc protection. However, the arc protection work clothing that has been known hitherto cannot satisfy the demand sufficiently. Work clothing containing a large amount of aramid fibers is expensive. When an attempt is made to lower the price of work clothing by reducing the use amount of the aramid fibers, a fabric weight increases in order to maintain desired properties. As a result, the clothing becomes thick and heavy, resulting in operation difficulty.

Patent document 1 describes thread and the like for arc prevention and fire prevention, containing 40 to 70% by weight of modacrylic fibers, 5 to 20% by weight of para-aramid fibers, and 10 to 40% by weight of m-aramid fibers, and the thread and the like further may contain nylon. However, the thread and the like require at least 30% by weight of aramid fibers. This has been an obstacle to the inexpensive supply of arc protection work clothing.

Patent document 2 describes a fiber composition and the like, containing about 40% to 65% by weight of modacrylic fibers containing antimony or FR acrylic fibers, about 10% to 50% by weight of cotton or FR cotton fibers, about 25% by weight or less of nylon, and more than about 3% by weight and less than about 10% by weight of para-aramid fibers. However, in order to enhance arc protection, it is necessary to increase a fabric weight.

### PRIOR ART DOCUMENT

### Patent Document

Patent document 1: JP 2007-529649 A

Patent document 2: US 2006/0292953 A1

### DISCLOSURE OF INVENTION

### Problem to be Solved by the Invention

It is an object of the present invention to inexpensively provide arc protection clothing lighter than that of the conventional art and fabric to be used for the arc protection clothing. More specifically, it is an object of the present invention to inexpensively provide fabric having a specific ATPV (arc thermal performance value (ATPV) per unit fabric weight) of not less than 1.3 (cal•yd²)/(cm²•oz) in an arc test based on ASTM F1959/F1959M-06ae1 (Standard Test Method for Determining the Arc Rating of Materials for Clothing) (hereinafter referred to simply as “arc test”) in order to satisfy the standard shown in NFPA 70E defined by National Fire Protection Association, and thread forming the fabric. In particular, it is an object of the present invention to provide the thread and fabric containing aramid fibers in a use amount of 20% by weight or less relative to the entire fibers. Further, in particular, it is an object of the present invention to obtain fabric having an ATPV of not less than 8 cal/cm² while having a fabric weight of about 6 oz/yd².

### Means for Solving Problem

The inventor of the present invention found that fabric containing 40 to 65% by weight of modacrylic fibers based on the thread weight, the modacrylic fibers containing at least 8% by weight of antimony oxide relative to the resin weight of the modacrylic fibers, 26 to 45% by weight of natural cellulosic fibers based on the thread weight, 5 to 15% by weight of nylon fibers based on the thread weight, and 1 to 20% by weight of para-aramid fibers based on the thread weight has a specific ATPV of not less than 1.3 (cal•yd²)/(cm²•oz) in an arc test based on ASTM F1959/F1959M-06ae1 (Standard Test Method for Determining the Arc Rating of Materials for Clothing) to achieve the present invention.

One of the features of the present invention is fabric containing: 40 to 65% by weight of modacrylic fibers based on a thread weight, the modacrylic fibers containing at least 8% by weight of antimony oxide relative to a resin weight of the modacrylic fibers; 26 to 45% by weight of natural cellulosic fibers based on the thread weight; 5 to 15% by weight of nylon fibers based on the thread weight; and 1 to 20% by weight of para-aramid fibers based on the thread weight.

Another feature of the present invention is arc protection work clothing including the fabric.

Further, the inventor of the present invention found that fabric containing 40 to 65% by weight of modacrylic fibers based on the fabric weight, the modacrylic fibers containing at least 8% by weight of antimony oxide relative to the resin weight of the modacrylic fibers, 26 to 45% by weight of natural cellulosic fibers based on the fabric weight, 5 to 15% by weight of nylon fibers based on the fabric weight, and 1 to 20% by weight of para-aramid fibers based on the fabric weight has a specific ATPV of not less than 1.3 (cal•yd²)/(cm²•oz) in an arc test based on ASTM F1959/F1959M-06ae1 (Standard Test Method for Determining the Arc Rating of Materials for Clothing) to achieve the present invention.

One of the features of the present invention is fabric containing: 40 to 65% by weight of modacrylic fibers based on a fabric weight, the modacrylic fibers containing at least 8% by weight of antimony oxide relative to a resin weight of the modacrylic fibers; 26 to 45% by weight of natural cellulosic fibers based on the fabric weight; 5 to 15% by weight of nylon fibers based on the fabric weight; and 1 to 20% by weight of para-aramid fibers based on the fabric weight.

Another feature of the present invention is arc protection work clothing including the fabric.

### Effects of the Invention

The present invention can inexpensively provide arc protection work clothing lighter than that of the conventional art. More specifically, the present invention can inexpensively provide fabric having a specific ATPV of not less than 1.3 (cal•yd²)/(cm²•oz) in an arc test and thread forming the fabric. In particular, the present invention can provide the thread and fabric containing aramid fibers in a use amount of 20% by weight or less of the entire fibers.

That is, the present invention can provide fabric exhibiting arc resistance having an ATPV of not less than 8 cal/cm² while having a fabric weight of about 6 oz/yd².

### DESCRIPTION OF THE INVENTION

It is appropriate that the fabric of the present invention contains 40 to 65% by weight of modacrylic fibers based on the thread weight, the modacrylic fibers containing at least 8% by weight of antimony oxide relative to the resin weight of the modacrylic fibers, 26 to 45% by weight of natural cellulosic fibers based on the thread weight, 5 to 15% by weight of nylon fibers based on the thread weight, and 1 to 20% by weight of para-aramid fibers based on the thread weight, and the fabric may contain other additional components as long as a specific ATPV for providing light arc protection work clothing is obtained.

Further, it is appropriate that the fabric of the present invention contains 40 to 65% by weight of modacrylic fibers based on the fabric weight, the modacrylic fibers containing at least 8% by weight of antimony oxide relative to the resin weight of the modacrylic fibers, 26 to 45% by weight of natural cellulosic fibers based on the fabric weight, 5 to 15% by weight of nylon fibers based on the fabric weight, and 1 to 20% by weight of para-aramid fibers based on the fabric weight, and the fabric may contain other additional components as long as a specific ATPV for providing light arc protection work clothing is obtained.

As the modacrylic fibers in the present invention, fibers containing at least 8% by weight of antimony oxide relative to the resin weight of the modacrylic fibers, which are a copolymer obtained by copolymerizing 40 to 70% by weight of acrylonitrile with another component, can be preferably used. As another component, there may be used 30 to 60% by weight of a halogen-containing vinyl monomer. As another component, there may also be given 0 to 3% by weight of a monomer containing a sulfonic acid group.

When the content of a component derived from acrylonitrile in the modacrylic fibers is less than 40% by weight, the heat resistance of fabric to be obtained is insufficient, and when the content of a component derived from acrylonitrile in the modacrylic fibers is more than 70% by weight, an effect sufficient for flame retardance is not obtained.

Examples of the halogen-containing vinyl monomer include vinyl chloride, vinylidene chloride, and vinyl bromide, and one or at least two kinds thereof are used. When the content of a component derived from the halogen-containing vinyl monomer in the modacrylic fibers is less than 30% by weight, an effect sufficient for flame retardance is not obtained, and when the content of a component derived from the halogen-containing vinyl monomer in the modacrylic fibers is more than 60% by weight, the heat resistance of fabric to be obtained is insufficient.

As the monomer containing a sulfonic acid group, methacrylsulfonic acid, allylsulfonic acid, styrenesulfonic acid, 2-acrylamide-2-methylpropanesulfonic acid, and salts thereof can be used preferably. The monomers containing a sulfonic acid group may be used alone or in a combination of at least two kinds. Examples of the salts include but are not limited to a sodium salt, a potassium salt, and an ammonium salt. The monomer containing a sulfonic acid group can be used if necessary. However, when the content of a component derived from the monomer containing a sulfonic acid group in the modacrylic fibers is more than 3% by weight, the spinnability of the modacrylic fibers during production degrades.

Examples of antimony oxide that may be contained in the modacrylic fibers include antimony trioxide, antimony tetraoxide, and antimony pentoxide. The amount of antimony oxide to be added is preferably at least 8% by weight, more preferably at least 9% by weight, still more preferably at least 10% by weight, still further preferably at least 11% by weight based on the total resin weight of the modacrylic fibers.

Examples of the modacrylic fibers that can be used in the present invention include Protex-M and Protex-C manufactured by Kaneka Corporation.

The amount of the modacrylic fibers contained in 100% by weight of the fabric of the present invention is preferably 40 to 65% by weight, more preferably 45 to 60% by weight, still more preferably 50 to 55% by weight.

Examples of the natural cellulosic fibers in the present invention include cotton and FR treated cotton. The amount of the natural cellulosic fibers contained in 100% by weight of the fabric of the present invention is preferably 26 to 45% by weight, more preferably 30 to 40% by weight, still more preferably 32 to 38% by weight.

The nylon fibers in the present invention are fibers made of an aliphatic polyamide polymer. Specific examples thereof include polyhexamethylene adipamide (nylon 66), polycaprolactam (nylon 6), polybutyrolactam (nylon 4), poly(9-aminononaic acid) (nylon 9), polyenanthlactam (nylon 7), polycapryllactam (nylon 8), and polyhexamethylene sebacamide (nylons 6, 10). The nylon fibers may be used in a combination of at least two kinds. The amount of the nylon fibers contained in 100% by weight of the fabric of the present invention is preferably 5 to 15% by weight, more preferably 7 to 13% by weight, still more preferably 8 to 12% by weight.

Examples of the para-aramid fibers in the present invention include p-aramid and/or p-aramid copolymerized with diaminophenylene-terephthalamide. The p-aramid is also called poly(paraphenylene terephthalamide). The amount of the para-aramid fibers contained in 100% by weight of the fabric of the present invention is preferably 1 to 20% by weight, more preferably 2 to 15% by weight, still more preferably 3 to 10% by weight.

Examples of the p-aramid that can be used in the present invention include Twaron (registered trademark, manufactured by Teijin Ltd.) and Kevlar (registered trademark, manufactured by Du Pont Co., Ltd.). As an example of p-aramid copolymerized with diaminophenylene-terephthalamide, there may be given Technora (registered trademark, manufactured by Teijin Ltd.).

The fabric of the present invention may be formed of one kind of thread or a plurality of kinds of threads. The thread forming the fabric of the present invention can be produced by a known spinning method. Examples of the spinning method include but are not limited to a ring spinning method and open-end spinning.

The fabric of the present invention can be produced by a known fabric-forming method through use of the above-mentioned thread. Examples of the form of the fabric include but are not limited to woven fabric, knit fabric, and nonwoven fabric. The woven fabric may be subjected to mixed weaving, and the knit fabric may be mixed knitting.

The fabric weight of the fabric of the present invention is represented by a weight per unit area of the fabric. Herein, the fabric weight is represented by an ounce amount per square yard, that is, “oz/yd²”.

The arc resistance of the fabric of the present invention can be evaluated in accordance with an arc test based on ASTM F1959/F1959M-06ae1 (Standard Test Method for Determining the Arc Rating of Materials for Clothing) (hereinafter referred to simply as “arc test”). If a specific ATPV of not less than 1.3 (cal•yd²)/(cm²•oz) is achieved in the arc test, it can be expected to obtain fabric achieving an ATPV of not less than 8 cal/cm² while having a fabric weight of about 6 oz/yd².

The fabric of the present invention not only has light weight and arc resistance but also is excellent in abrasion resistance, dyeability, and water absorbability.

The clothing of the present invention can be produced by a known method through use of the fabric of the present invention. The clothing of the present invention preferably can be used, in particular, as arc protection work clothing. The clothing of the present invention can be used as single-layer arc protection work clothing through use of the fabric of the present invention as a single layer, and further, can be used as multi-layer arc protection work clothing through use of the fabric of the present invention as a multi-layer of at least two layers. Needless to say, the clothing of the present invention can be used as multi-layer arc protection work clothing through use of the fabric of the present invention together with another fabric as a multi-layer.

The clothing of the present invention not only has light weight and arc resistance but also is excellent in abrasion resistance, dyeability, a water absorbability, and moisture permeability. Therefore, the clothing of the present invention can be used for arc protection work clothing that satisfies the FR standard, and can provide work clothing that has high visibility and is highly comfortable to wear. Further, even if the clothing is washed repeatedly, its flame retardance can be maintained.

### EXAMPLES

Hereinafter, the present invention is described in detail by way of examples.

It should be noted that the present invention is not limited to the examples. Prior to the description of the examples, a method for measuring property values in the present specification are shown below.

### Test Example Arc Test

A fabric weight (oz/yd²) and an ATPV (cal/cm²) were determined in accordance with an arc test based on ASTM F1959/F1959M-06ae1 (Standard Test Method for Determining the Arc Rating of Materials for Clothing) (hereinafter referred to simply as “arc test”). A specific ATPV ((cal•yd²)/(cm²•oz)) that was an ATPV per unit fabric weight was calculated.

### Production Examples 1-11

Modacrylic fibers (represented by “AF1” in tables) obtained by adding 10% by weight of antimony trioxide relative to the resin weight of a copolymer to the copolymer containing 50% by weight of acrylonitrile and 49% by weight of vinylidene chloride, and sodium styrenesulfonate; modacrylic fibers (represented by “AF2” in the tables) obtained by adding 25% by weight of antimony trioxide relative to the resin weight of a copolymer to the copolymer containing 50% by weight of acrylonitrile and 49% by weight of vinylidene chloride, and sodium styrenesulfonate; nylon 66 (represented by “NY” in the tables); cotton (represented by “Cot” in the tables); FR rayon (Visil (registered trademark) manufactured by Sateri Oy, Finland, represented by “Vis” in the tables; Lenzing FR (registered trademark) manufactured by Lenzing AG, represented by “LFR” in the tables); para-aramid fibers (Twaron (registered trademark) manufactured by Teijin Ltd., represented by “Twa” in the tables), and polyethyleneterephthalate (represented by “PET” in the tables) were mixed in fiber composition shown in Tables 1 to 5. Each fiber mixture was subjected to spinning and twisting by an ordinary spinning method to obtain spun yarn. Fabric was produced through use of each spun yarn.

### Experiment 1

An arc test was performed with respect to the fabric produced in Production Examples 1 to 4. Table 1 shows the results. In Examples 1 to 4 (Production Examples 1 to 4) using AF1 (average content of antimony trioxide: 10% by weight) and AF2 (average content of antimony trioxide: 25% by weight) in which the amount of antimony in the modacrylic fibers used in the examples was not less than 8% by weight relative to the resin weight of the modacrylic fibers, a specific ATPV of not less than 1.3 was achieved. There is no prior art that sufficiently discloses which modacrylic fibers should be used for obtaining high arc resistance in fabric having a smaller fabric weight, and the present invention clarified which modacrylic fibers should be used.

TABLE 1

| | Fabric | Fiber composition | | | | | Result | | |
|---|---|---|---|---|---|---|---|---|---|
| | production | AF2 | AF1 | NY | Cot | Twa | Fabric weight | ATPV | Specific ATPV |
| Example No. | example No. | % | % | % | % | % | oz/yd² | cal/cm² | cal · yd²/cm² · oz |
| Example 1 | Production | 0 | 50 | 10 | 35 | 5 | 5.1 | 7.2 | 1.4 |
| | Example 1 | | | | | | | | |
| Example 2 | Production | 50 | 0 | 10 | 35 | 5 | 5.2 | 7.7 | 1.5 |
| | Example 2 | | | | | | | | |
| Example 3 | Production | 0 | 50 | 10 | 30 | 10 | 5.3 | 7.0 | 1.3 |
| | Example 3 | | | | | | | | |
| Example 4 | Production | 50 | 0 | 10 | 30 | 10 | 5.3 | 6.8 | 1.3 |
| | Example 4 | | | | | | | | |

### Experiment 2

An arc test was performed with respect to the fabric produced in Production Examples 1, 5, and 6. Table 2 shows the results. Although a specific ATPV of not less than 1.3 was achieved in Example 1 (Production Example 1) using, as cellulosic fibers, cotton which was natural cellulosic fibers, a specific ATPV was less than 1.3 in Comparative Example 1 (Production Example 5) and Comparative Example 2 (Production Example 6) using FR rayon. Although the U.S. Publication US 2006/0292953 (Patent Document 2) describes that FR cotton can be used, it was shown in this experiment that, in order to obtain high arc resistance in fabric having a smaller fabric weight, it is not necessary to use FR cotton, but rather acceptable to use non-FR natural cellulosic fibers.

TABLE 2

| | Fabric | Fiber composition | | | | | | Result | | |
|---|---|---|---|---|---|---|---|---|---|---|
| | production | AF1 | NY | TWA | Cot | Vis | LFR | Fabric weight | ATPV | Specific ATPV |
| Example No. | example No. | % | % | % | % | % | % | oz/yd² | cal/cm² | cal · yd²/cm² · oz |
| Example 1 | Production | 50 | 10 | 5 | 35 | 0 | 0 | 5.1 | 7.2 | 1.4 |
| | Example 1 | | | | | | | | | |
| Comparative | Production | 50 | 10 | 5 | 0 | 35 | 0 | 4.2 | 4.7 | 1.1 |
| Example 1 | Example 5 | | | | | | | | | |
| Comparative | Production | 50 | 10 | 5 | 0 | 0 | 35 | 5.1 | 5.5 | 1.1 |
| Example 2 | Example 6 | | | | | | | | | |

### Experiment 3

An arc test was performed with respect to the fabric produced in Production Examples 1, 3, 7, and 8. Table 3 shows the results. As is understood from the comparison between Example 3 (Production Example 3) and Comparative Example 3 (Production Example 7) and the comparison between Example 1 (Production Example 1) and Comparative Example 4 (Production Example 8), a specific ATPV is less than 1.3 when nylon fibers are not contained, and a specific ATPV tends to decrease even if the added amount of nylon fibers is increased. Although the U.S. Publication US 2006/0292953 (Patent Document 2) describes that about 25% by weight or less of nylon is used, it was shown in this experiment that, in order to obtain high arc resistance in fabric having a smaller fabric weight, it is necessary to use 5 to 15% by weight of nylon fibers.

TABLE 3

| | Fabric | Fiber composition | | | | Result | | |
|---|---|---|---|---|---|---|---|---|
| | production | AF2 | NY | Cot | Twa | Fabric weight | ATPV | Specific ATPV |
| Example No. | example No. | % | % | % | % | oz/yd² | cal/cm² | cal · yd²/cm² · oz |
| Comparative | Production | 50 | 0 | 40 | 10 | 5.4 | 6.5 | 1.2 |
| Example 3 | Example 7 | | | | | | | |
| Example 3 | Production | 50 | 10 | 30 | 10 | 5.3 | 7.0 | 1.3 |
| | Example 3 | | | | | | | |
| Example 1 | Production | 50 | 20 | 25 | 5 | 5.4 | 7.0 | 1.3 |
| | Example 1 | | | | | | | |
| Comparative | Production | 50 | 10 | 35 | 5 | 5.1 | 7.2 | 1.4 |
| Example 4 | Example 8 | | | | | | | |

### Experiment 4

An arc test was performed with respect to the fabric produced in Production Examples 1 and 9. Table 4 shows the results. In Comparative Example 5 (Production Example 9) in which the nylons fibers in Example 1 (Production Example 1) were replaced by PET fibers, a specific ATPV was less than 1.3.

TABLE 4

| | Fabric | Fiber composition | | | | | Result | | |
|---|---|---|---|---|---|---|---|---|---|
| | production | AF2 | NY | Cot | Twa | PET | Fabric weight | ATPV | Specific ATPV |
| Example No. | example No. | % | % | % | % | % | oz/yd² | cal/cm² | cal · yd²/cm² · oz |
| Example 1 | Production | 50 | 10 | 35 | 5 | 0 | 5.1 | 7.2 | 1.4 |
| | Example 1 | | | | | | | | |
| Comparative | Production | 50 | 0 | 35 | 5 | 10 | 5.3 | 6.3 | 1.2 |
| Example 5 | Example 9 | | | | | | | | |

### Experiment 5

An arc test was performed with respect to the fabric produced in Production Examples 1 to 4 and 10. Table 5 shows the results. In Comparative Example 6 (Production Example 10) in which para-aramid fibers were not added, fabric was torn during measurement, and hence, sufficient arc resistance was not obtained. On the other hand, as is understood from the comparison between Example 2 (Production Example 2) and Example 4 (Production Example 4), and the comparison between Example 1 (Production Example 1) and Example 3 (Production Example 3), a specific ATPV tended to decrease even if the content of para-aramid fibers was increased from 5% by weight to 10% by weight.

TABLE 5

| | Fabric | Fiber composition | | | | | Result | | |
|---|---|---|---|---|---|---|---|---|---|
| | production | AF2 | AF1 | NY | Cot | Twa | Fabric weight | ATPV | Specific ATPV |
| Example No. | example No. | % | % | % | % | % | oz/yd² | cal/cm² | cal · yd²/cm² · oz |
| Comparative | Production | 50 | 0 | 10 | 40 | 0 | 5.3 | N.D | N.D. |
| Example 6 | Example 10 | | | | | | | | |
| Example 2 | Production | 50 | 0 | 10 | 35 | 5 | 5.2 | 7.7 | 1.5 |
| | Example 2 | | | | | | | | |
| Example 4 | Production | 50 | 0 | 10 | 30 | 10 | 5.3 | 6.8 | 1.3 |
| | Example 4 | | | | | | | | |
| Example 1 | Production | 0 | 50 | 10 | 35 | 5 | 5.1 | 7.2 | 1.4 |
| | Example 1 | | | | | | | | |
| Example 3 | Production | 0 | 50 | 10 | 30 | 10 | 5.3 | 7.0 | 1.3 |
| | Example 3 | | | | | | | | |

* N.D. indicates that fabric is torn due to low arc resistance and cannot be measured.

### Experiment 6

Fabric in which a fabric weight was increased from 5.2 oz/yd² to 5.6 oz/yd² through use of the fiber composition of Production Example 2 exhibiting the highest specific ATPV in the production examples was produced in Production Example 11. An arc test was performed with respect to the fabric. Table 6 shows the results. The fabric shown in Example 5 (Production Example 11) achieved an ATPV of 8.9 cal/cm².

TABLE 6

| | Fabric | Fiber composition | | | | Result | | |
|---|---|---|---|---|---|---|---|---|
| | production | AF2 | NY | Cot | Twa | Fabric weight | ATPV | Specific ATPV |
| Example No. | example No. | % | % | % | % | oz/yd² | cal/cm² | cal · yd²/cm² · oz |
| Example 5 | Production | 50 | 10 | 35 | 5 | 5.6 | 8.9 | 1.6 |
| | Example 11 | | | | | | | |

1. Fabric comprising: 40 to 65% by weight of modacrylic fibers based on a fabric weight, the modacrylic fibers comprising at least 8% by weight of antimony oxide relative to a resin weight of the modacrylic fibers; 26 to 45% by weight of natural cellulosic fibers based on the fabric weight; 5 to 15% by weight of nylon fibers based on the fabric weight; and 1 to 20% by weight of para-aramid fibers based on the fabric weight.

2. The fabric according to claim 1, wherein the modacrylic fibers are a copolymer obtained by copolymerizing 40 to 70% by weight of acrylonitrile with another component.

3. The fabric according to claim 2, wherein the another component is 30 to 60% by weight of a halogen-containing vinyl monomer.

4. The fabric according to claim 3, wherein the halogen-containing vinyl monomer is at least one compound selected from the group consisting of vinyl chloride, vinylidene chloride, and vinyl bromide.

5. The fabric according to claim 3, wherein the another component further comprises 0 to 3% by weight of a monomer containing a sulfonic acid group.

6. The fabric according to claim 5, wherein the monomer containing a sulfonic acid group is at least one compound selected from the group consisting of methacrylsulfonic acid, allylsulfonic acid, styrenesulfonic acid, 2-acrylamide-2-methylpropanesulfonic acid, and salts thereof.

7. The fabric according to claim 1, wherein the antimony oxide is at least one compound selected from the group consisting of antimony trioxide, antimony tetraoxide, and antimony pentoxide.

8. The fabric according to claim 1, wherein the natural cellulosic fibers are cotton.

9. The fabric according to claim 1, wherein the nylon fibers are at least one kind of fibers selected from the group consisting of polyhexamethylene adipamide (nylon 66), polycaprolactam (nylon 6), polybutyrolactam (nylon 4), poly(9-aminononaic acid) (nylon 9), polyenanthlactam (nylon 7), polycapryllactam (nylon 8), and polyhexamethylene sebacamide (nylons 6, 10).

10. The fabric according to claim 1, wherein the para-aramid fibers are p-aramid and/or p-aramid copolymerized with diaminophenylene-terephthalamide.

11. The fabric according to claim 1, having a specific ATPV value of not less than 1.3 (cal•yd²)/(cm²•oz) in an arc test based on ASTM F1959/F1959M-06ae1 (Standard Test Method for Determining the Arc Rating of Materials for Clothing).

12. Arc protection work clothing comprising the fabric according to claim 1.

13. The arc protection work clothing according to claim 12, wherein the fabric has a specific ATPV value of not less than 1.3 (cal•yd²)/(cm²•oz) in an arc test based on ASTM F1959/F1959M-06ae1 (Standard Test Method for Determining the Arc Rating of Materials for Clothing).
